(19) United States
(12) Patent Application Publication
(10) Pub. No.: US 2024/0312020 A1
(43) Pub. Date: Sep. 19, 2024

(54) CONDITIONED SMART IMAGE CROPPING

(71) Applicant: Microsoft Technology Licensing, LLC, Redmond, WA (US)

(72) Inventors: Mingxi CHENG, Los Angeles, CA (US); Ji LI, San Jose, CA (US); Zhihang ZHONG, Hangzhou (CN); Zhirong WU, Beijing (CN); Han HU, Beijing (CN); Yuhui YUAN, Beijing (CN); Stephen Ssu-te LIN, Beijing (CN)

(73) Assignee: Microsoft Technology Licensing, LLC, Redmond, WA (US)

(21) Appl. No.: 18/185,791

(22) Filed: Mar. 17, 2023

(51) Int. Cl. G06T 7/11; G06V 10/25; G06V 10/44; G06V 10/74; G10L 15/26

(52) U.S. Cl. CPC G06T 7/11; G06V 10/25; G06V 10/44; G06V 10/761; G10L 15/26; G06T 2207/20132

(57) ABSTRACT

A system for cropping an image is disclosed, which performs receiving a source image and user intention data; determining a target feature based on the user intention data; identifying a plurality of visual features within the source image; determining a contextual relevance between the target feature and each identified visual feature of the source image; identifying, based on the determined contextual relevance between the target feature and each identified visual feature of the source image, one or more cropping candidate portions within the source image; cropping, based on the one or more cropping candidate portions, the source image to generate a plurality of cropped images; and causing the plurality of cropped images to be displayed on a display.

### BACKGROUND

Many people use a computer-based content creation tool (e.g., Microsoft™ Designer™, Adobe™ Photoshop, etc.) to create a visual content (e.g., a magazine page, webpage banner, Facebook™ post, email template, newspaper advertisement, etc.). In doing so, users may need an image or images showing particular objects or features. For example, when creating a newspaper advertisement for promoting a dog adoption day, a user may need an image or images of one or more dogs to convey the objectives of the visual content more effectively. The user may then conduct online and/or offline searches to find and download images, and visually inspect and compare those images to find which images are more suitable and/or effective for the objectives. Those suitable images, however, may not be in an immediately useable condition and hence need to be edited. For example, the user may find an image showing dogs that he or she would like to use, but those dogs might not be located at the center of the image or proportionally too small compared to the entire image. Then, the user may need to manually edit (e.g., crop, resize, etc.) the image using image editing functions available on the content creation tool, which is time consuming and requires human intelligence, training, skill and effort, which cannot be easily replicated even with a state-of-art machine.

### SUMMARY

In an implementation, a system for cropping an image includes a processor and a computer-readable medium in communication with the processor. The computer-readable medium includes instructions that, when executed by the processor, cause the processor to control the system to perform functions of: receiving a source image and user intention data; determining a target feature based on the user intention data; identifying a plurality of visual features within the source image; determining a contextual relevance between the target feature and each identified visual feature of the source image; identifying, based on the determined contextual relevance between the target feature and each identified visual feature of the source image, one or more cropping candidate portions within the source image; cropping, based on the one or more cropping candidate portions, the source image to generate a plurality of cropped images; and causing the plurality of cropped images to be displayed on a display.

In another implementation, a method of cropping an image includes receiving a source image and user intention data; determining a target feature based on the user intention data; identifying a plurality of visual features within the source image; determining a contextual relevance between the target feature and each identified visual feature of the source image; identifying, based on the determined contextual relevance between the target feature and each identified visual feature of the source image, one or more cropping candidate portions within the source image; cropping, based on the one or more cropping candidate portions, the source image to generate a plurality of cropped images; and causing the plurality of cropped images to be displayed on a display.

In another implementation, a non-transitory computer-readable medium includes instructions that, when executed by a processor, cause the processor to control a system to perform receiving a source image and user intention data; determining a target feature based on the user intention data; identifying a plurality of visual features within the source image; determining a contextual relevance between the target feature and each identified visual feature of the source image; identifying, based on the determined contextual relevance between the target feature and each identified visual feature of the source image, one or more cropping candidate portions within the source image; cropping, based on the one or more cropping candidate portions, the source image to generate a plurality of cropped images; and causing the plurality of cropped images to be displayed on a display.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 conceptually illustrates conditioned smart image cropping.

FIG. 2 illustrates an implementation of a system configured to perform the conditioned smart image cropping.

FIG. 3 illustrates a flow diagram showing example steps of the conditioned smart image cropping.

FIG. 4 illustrates an example contextual analysis operation.

FIG. 5 illustrates an example contextual relevance determination operation.

FIG. 6A illustrates an example source image, and FIG. 6B illustrates a plurality of example cropping candidate portions identified by the contextual analysis operation of FIG. 4.

FIG. 7 illustrates an example source image cropping operation.

FIGS. 8A, 8B and 8C illustrate examples of the cropped images.

FIG. 9 is a block diagram showing an example computer system upon which aspects of this disclosure may be implemented.

### DETAILED DESCRIPTION

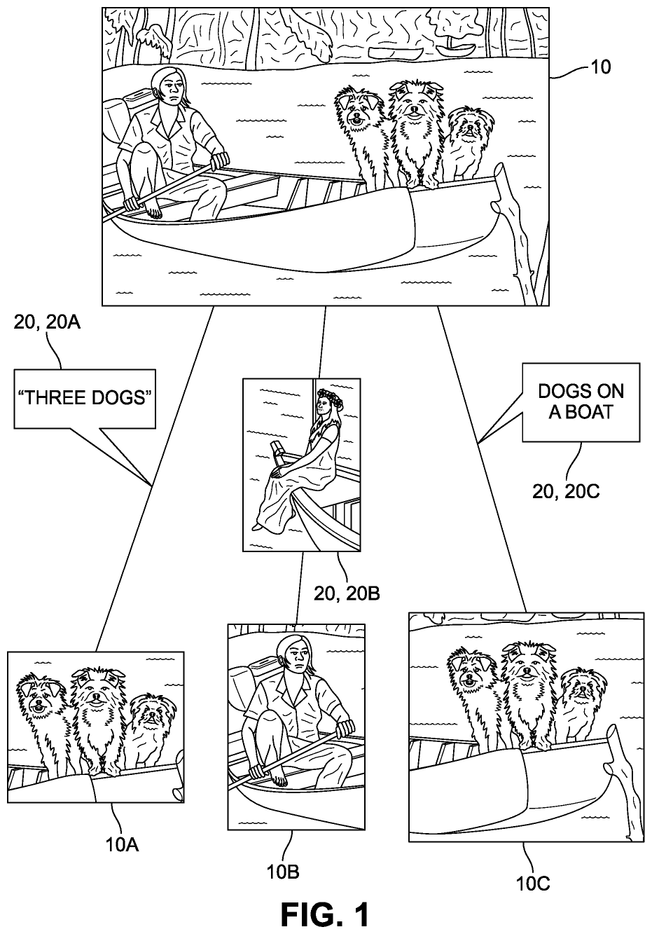

The invention is directed to conditioned smart image cropping for generating a set of cropped images based on a user's intention. FIG. 1 shows an example image 10 containing various visual features, for example, a river, a boat, a woman, three dogs, the boat floating on the river, the woman sitting on the boat, the woman rowing the boat, the woman positioned at the left side of the image 10, the three dogs standing on the boat, the three dogs facing toward a viewer of the image 10, the three dogs positioned at the right side of the image 10, etc. User intention data 20 may be received, which indicates one or more target features desired by the user. The user intention data 20 may be any one or more of text data, audio data, image data, video data, etc. For example, user intention data 20 may be text data 20A containing letters “three dogs,” which may be entered or sent by the user. Contextual information (e.g., three dogs) may be extracted from the text data 20A, and the image 10 may be analyzed to find one or more portions showing the target feature or features. Such portions of the image 10 are referred to as cropping candidate portions. Based on the cropping candidate portions, the image 10 is cropped to generate one or more cropped images that primarily show the target feature or features. For example, in response to extracting “three dogs” from the text data 20A, a portion 10A of the image 10 showing the three dogs may be determined as a cropping candidate portion. Then, based on the cropping candidate portion 10A, the image 10 may be cropped to generate one or more cropped images, each primarily showing the same three dogs but having a different image configuration (e.g., a size, aspect ratio, etc.). Different extracted contextual information may result in a different set of cropped images. For example, when image data 20B is received as the user intention data 20, the image data 20B may be processed and analyzed to extract a woman sitting on a boat as the contextual information. Then, the image 10 may be analyzed to find the visual feature or features corresponding to the extracted contextual information (e.g., a woman sitting on a boat), which may result in determining a portion 10B as a cropping candidate portion. As another example, the user intention data 20 may be audio data 20C capturing the user's speech saying “dogs on a boat.” The image 10 may then be analyzed to find a portion containing the visual feature corresponding to extracted contextual information (e.g., “dogs on a boat), and a portion 10C of the image 10, primarily showing the three dogs and a portion of the boat on which the three dogs are standing, may be determined as a cropping candidate portion. As such, the image 10 may be cropped to meet the user's intention even if the user is not familiar with computer-based content creation tools, which is referred to as conditioned smart image cropping. Therefore, this disclosure provides technical solutions to the technical problems that, in order to obtain an image showing desired visual features, a user has to manually edit (e.g., crop, resize, etc.) the image by himself or herself, which is time consuming and cannot be replicated even with a state-of-art machinery. Also, a large number of images may be searched to find those images containing the visual features desired by the user, and those found images may be cropped to generate a collection of cropped images for the user's review and selection. Hence, the disclosure can provide a significantly increased number of cropped images that show the desired visual features and hence are immediately usable for visual content creation projections.

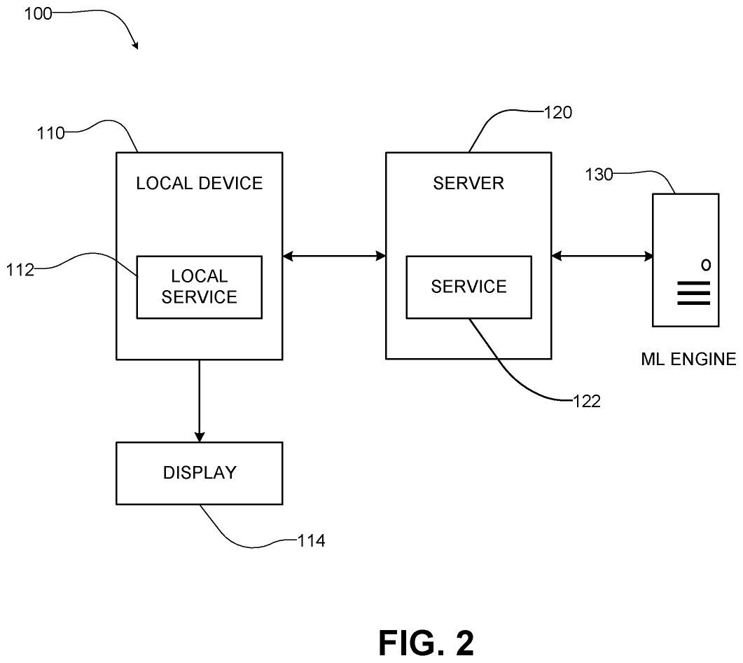

FIG. 2 illustrates an implementation of a system 100 configured to perform conditioned smart image cropping. The system 100 may include a local device 110, a server 120, and an ML engine 130. The local device 110 is representative of any physical or virtual computing system, device, or collection thereof, such as a smart phone, laptop computer, desktop computer, hybrid computer, tablet computer, gaming machine, smart television, entertainment device, Internet appliance, virtual machine, wearable computer, as well as any variation or combination thereof. The local device 110 may operate remotely from the server 120, and hence may communicate with the server 120 by way of data and information exchanged over a suitable communication link or links. The local device 110 may implement some of or all the functions for performing conditioned smart image cropping for a user of the local device 110. The local device 110 may also include or be in communication with the ML engine 130.

The local device 110 may host a local service 112 configured to perform some of or all the functions related to conditioned smart image cropping. The local service 112 is representative of any software application, module, component, or collection thereof, capable of performing conditioned smart image cropping. The local service 112 may operate independently from or as part of a software tool (e.g., web browser, content creation software, photo editing software, publishing software, word processing software, presentation software, web development software, blog software, graphic design software, etc.) for creating visual contents (e.g., photos, documents, presentations, postcards, calendars, menus, templates, notifications, web pages, blog postings, advertisements, public relations (PR)/promotion materials, etc.) or uploading or sharing such visual contents via one or more platforms, services, functions, etc. The local device 110 may include or be connected to a display 114, which may display a graphical user interface (GUI) for the local service 112 or the software tool.

In an implementation, the local service 112 may be implemented as a locally installed and executed application, streamed application, mobile application, or any combination or variation thereof, which may be configured to carry out operations or functions related to conditioned smart image cropping. Alternatively, the local service 112 may be implemented as part of an operating system (OS), such as Microsoft™ Windows™, Apple™ iOS™ Linux™, Google™ Chrome OS™, etc. The local service 112 may be implemented as a standalone application or may be distributed across multiple applications.

The server 120 is representative of any physical or virtual computing system, device, or collection thereof, such as, a web server, rack server, blade server, virtual machine server, or tower server, as well as any other type of computing system, which may, in some scenarios, be implemented in a data center, a virtual data center, or some other suitable facility. The server 120 may operate a conditioned smart image cropping service 122, which implements all or portions of the functions for performing conditioned smart image cropping. The service 122 may host, be integrated with, or be in communication with various data sources and processing resources, such as, data storages (not shown), the ML engine 130, etc. The service 122 may be any software application, module, component, or collection thereof capable of performing conditioned smart image cropping. In some cases, the service 122 is a standalone application carrying out various operations related to conditioned smart image cropping.

The features and functionality provided by the local service 112 and service 122 may be co-located or even integrated as a single application. In addition to the above-mentioned features and functionality available across application and service platforms, aspects of the conditioned smart image cropping may be carried out across multiple devices on a same or different computing devices. For example, some functionality for the conditioned smart image cropping may be provided by the local service 112 on the local device 10 and the local service 112 may communicate by way of data and information exchanged between with the server 120 or other devices. As another example, the local device 110 may operate as a so-called “thin client” in a virtual computing environment and receive video data that is to be displayed via the display 114. In this virtual computing scenario, the server 120 may carry out the entire conditioned smart image cropping functions.

To carry out the conditioned smart image cropping, the server 120 may include or be in communication with the ML engine 130. The ML engine 130 may be implemented based on a machine-learning (ML), which generally involves various algorithms that can automatically learn over time. The foundation of these algorithms is generally built on mathematics and statistics that can be employed to predict events, classify entities, diagnose problems, and model function approximations. As an example, the ML engine 130 may be trained to identify a plurality of visual features in an image, extract contextual information from the use intention data 20 (shown in FIG. 1), and identify one or more cropping candidate portions showing the visual features corresponding to the extract contextual information. The ML engine 130 may also be trained to crop the images based on the cropping candidate portions to generate a set of cropped images, which may be displayed via the display 114 of the local device 110.

In different implementations, a training system may be used that includes an initial ML model (which may be referred to as an “ML model trainer”) configured to generate a subsequent trained ML model from training data obtained from a training data repository. The generation of this ML model may be referred to as “training” or “learning.” The training system may include and/or have access to substantial computation resources for training, such as a cloud, including many computer server systems adapted for machine learning training. In some implementations, the ML model trainer may be configured to automatically generate multiple different ML models from the same or similar training data for comparison. For example, different underlying ML algorithms may be trained, such as, but not limited to, decision trees, random decision forests, neural networks, deep learning (for example, convolutional neural networks), support vector machines, regression (for example, support vector regression, Bayesian linear regression, or Gaussian process regression). As another example, size or complexity of a model may be varied between different ML models, such as a maximum depth for decision trees, or a number and/or size of hidden layers in a convolutional neural network.

Moreover, different training approaches may be used for training different ML models, such as, but not limited to, selection of training, validation, and test sets of training data, ordering and/or weighting of training data items, or numbers of training iterations. One or more of the resulting multiple trained ML models may be selected based on factors such as, but not limited to, accuracy, computational efficiency, and/or power efficiency. In some implementations, a single trained ML model may be produced. The training data may be continually updated, and one or more of the models used by the system can be revised or regenerated to reflect the updates to the training data. Over time, the training system (whether stored remotely, locally, or both) can be configured to receive and accumulate more and more training data items, thereby increasing the amount and variety of training data available for ML model training, resulting in increased accuracy, effectiveness, and robustness of trained ML models.

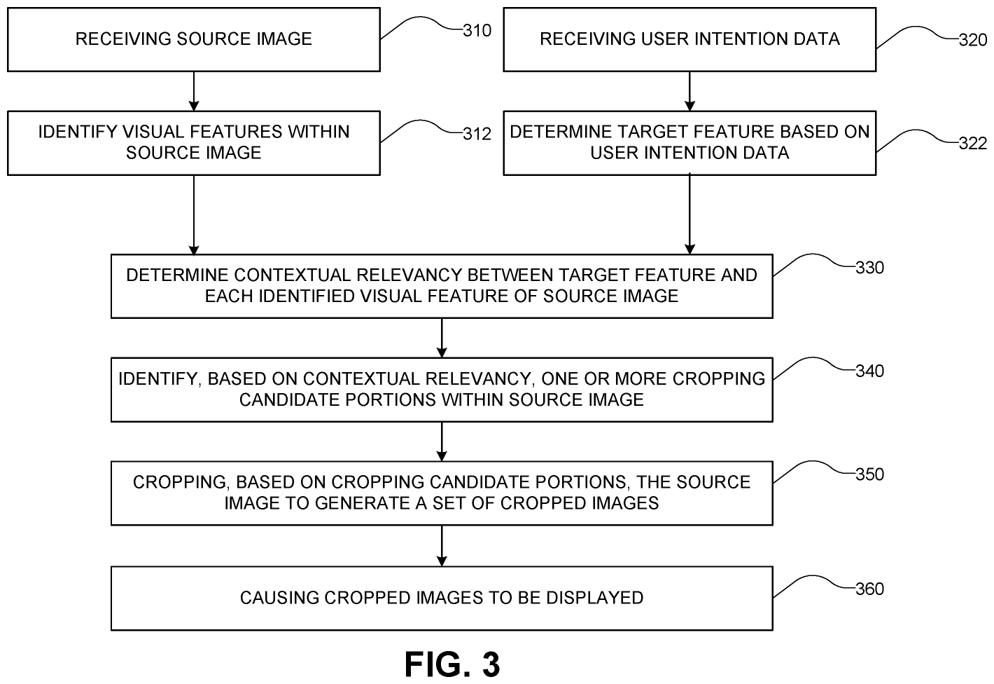

FIG. 3 illustrates a flow diagram showing a conditioned smart image cropping operation, which may be performed by, for example, the system 100 shown in FIG. 2. At step 310, the system 100 may receive a source image (e.g., the source image 10 shown in FIG. 1). The source image may be stored locally at the user's local device 110 or at a remote storage (e.g., server 120, cloud storage, etc.). The source image may be received by the local device 110 and transmitted to the server 120. Alternatively, the source image may be selected from a collection of images stored at or accessible by the server 120 or selected from images identified from internet searches. The source image may also be obtained from an image licensing service (e.g., Getty Images™, etc.), image archives, etc. At step 312, the system 100 may identify one or more visual features in the source image. For example, the system 100 may perform context recognition by analyzing various features shown in the source image 10, which may be performed by the server 120 in corporation with the ML engine 130. The identified visual features of the source image 10 may include water, a river, a boat, a woman, three dogs, the boat floating on the river, the woman sitting on the boat, the woman rowing the boat, the woman positioned at the left side of the image 10, the three dogs standing on the boat, the three dogs facing toward a view of the image 10, the three dogs positioned at the right side of the image 10, etc.

The system 100 may receive user intention data at step 320. As shown in FIG. 1, the user intention data may be one or more of text data, audio data, image data, video data, etc. The user intention data may be provided by the user himself or herself. For example, the user may provide, to the system 100, letters (e.g., “three dogs,” “a woman on a boat,” “three dogs standing on a boat,” etc.) that literarily characterize a target feature. The target feature may be contained in the user's speech captured in an audio file and/or in an image/video file containing one or more visual features. The user intention data may not need to be received from the user. For example, when the user is working on a project of creating a newspaper advertisement for promoting a dog adoption day, one or more target features may be inferred from the context of the project. For example, when a text “LET'S ADOPT PUPPIES!” is detected in the current visual content creation project, the system 100 may determine that the target feature desired by the user is one or more dogs.

Once the visual features are identified from the source image (at step 312) and the target feature (at step 322) is identified from the user intention data, the system 100 may determine a contextual relevance between the target feature (e.g., one or more dogs) with each of the identified visual features within the source image. For example, the system 100 may compare the “one or more dogs” target feature with the visual feature of “women sitting on the boat” shown in the image 10 and determine that this visual feature has a very low contextual relevance (e.g., less than 10%) to the target feature. The system 100 may then compare the target feature with another visual feature “three dogs” shown in the image 10 and determine that the “three dogs” visual feature has a high contextual relevance (more than 90%) to the target feature.

Based on the contextual relevance of each visual feature with respect to the target feature, at step 330, one or more cropping candidate portions may be identified from the source image. Each cropping candidate portion may show the visual feature having a contextual relevance equal to or higher than a threshold contextual relevance (e.g., 80% contextual relevance, etc.). For example, regarding the portion 10C of the image 10 (shown in FIG. 1) showing three dogs, the system 100 may determine the portion 10C has a contextual relevance of 95% with respect to the “three dogs” target feature, which is higher than the 80% threshold contextual relevance. The system 100 may then identify the portion 10C as a cropping candidate portion. On the other hand, the portion 10B showing the woman on the boat may be determined to have a 0% contextual relevance and hence may not be selected as the cropping candidate portion. Then, at step 350, the system 100 may crop the source image based on the one or more cropping candidate portions to generate a set of cropped images. Each cropped image may show the visual feature corresponding to the target feature but may have a different image configuration (e.g., a size, aspect ratio, etc.). For example, the system 100 may generate one cropped image primarily showing on the three dogs, and another cropped image which is slightly larger in a vertical direction than the first cropped image to show the three dogs and a portion of the boat on which the three dogs are standing. Those cropped images may then be displayed at step 360 via, for example, the display 114 of the local device 110. As such, upon explicitly or implicitly providing the user's intention characterizing the target feature, the system 100 may generate a number of cropped images that are highly contextually relevant to the target feature, thereby eliminating a need for the user to learn or be skilled with various functions of a visual content creation tool. Also, based on the target features, the system 100 may perform an image search to find a set of images that are contextually relevant to the target features and perform the conditioned smart image cropping on those images to generate a comprehensive collection of cropped images that have a very high contextual relevance to the target feature. Hence, the user may not need to provide or identify a source image, which may have a contextual relevance less than that of other images available to the system 100.

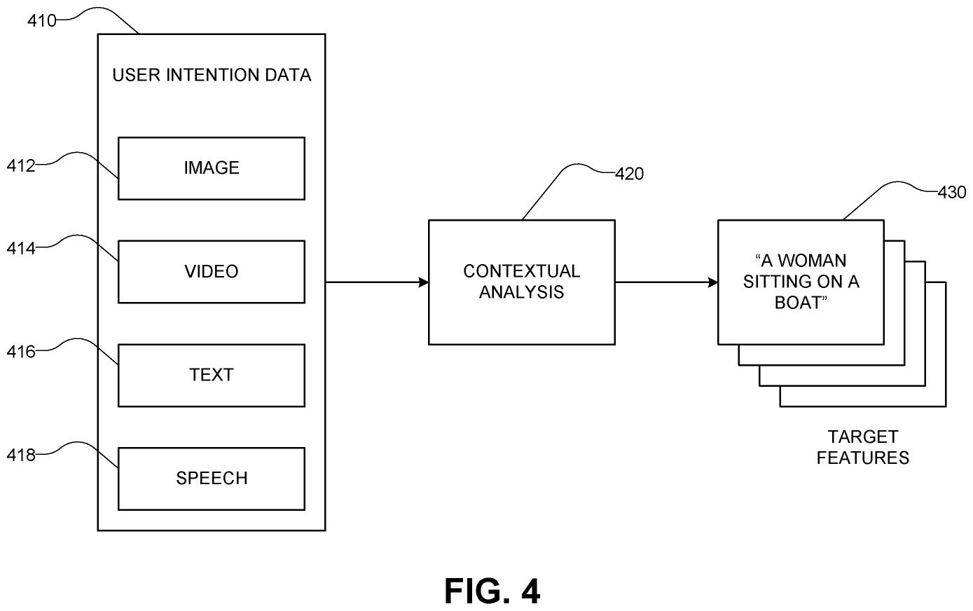

FIG. 4 conceptually illustrates an implementation of steps 320 and 322 shown in FIG. 3. The system 100 may receive user intention data 410 and perform contextual analysis 420 of the received user intention data 410 to determine one or more target features 430. The user intention data 410 may describe, characterize, suggest or imply the target feature or features desired by the user. The use intention data 410 may include at least one of image data 412, video data 414, text data 416, speech data 418, etc. The image data 412 may be, for example, an image file (e.g., a GIF or JPEG file, or the like) capturing one or more dogs, three dogs, white dog or dogs, dog or dogs on a boat, three white dogs, dog or dogs standing on a boat. The video data 414 may be, for example, a video file (e.g., an MPG or AVI file, or the like) capturing one or more dogs, white dog or dogs, three dogs, dog or dogs on a boat, dog or dogs standing on a boat. The text data 416 may be, for example, a text file (e.g., a TXT or DOC file, or the like) containing a string of letters, such as, “a dog,” “dogs,” “three dogs,” “three white dogs,” “three white dogs on a boat,” “three white dogs standing on a boat,” etc. The speech file 418 may be an audio file (e.g., a WAV or MP3 file, or the like) capturing user's speech saying, for example, “a dog,” “dogs,” “three dogs,” “three white dogs,” “three white dogs on a boat,” “three white dogs standing on a boat,” etc.

The system 100 may then perform a contextual analysis of the received user intention data 410 to extract one or more target features 430. For example, when the image data 412 is received as the user intention data 410, the system 100 may process the image data 412 to extract visual features shown in the image data 412. For example, when the image 20B (shown in FIG. 1) is provided as the user intention data 410, the system 100 may process the image 20B to extract one or more visual features, such as, water, a boat, a woman, a boat on a water, a woman on a boat, etc. Each of the extracted visual features may be output as a different target feature 430 of the user intention data 410. For example, the target features 430 extracted from the image 20B may include the first target feature that there is a woman, a second target feature that a woman is sitting on a boat, etc.

In an implementation, the ML engine 130 may be trained to analyze the user intention data 410 and extract one or more visual features shown in the user intention data 410. For example, the ML engine 130 may be provided with the video data 414 (e.g., a video clip) showing a person walking three dogs in a park. The ML engine 130 may then perform a contextual analysis of the video data 414 and determine that the video data 414 is directed to dogs, dog-walking, dog-walking in a park, etc., which may be respectively determined as a target feature. In an implementation, the target features may be prioritized based on a contextual broadness, ambiguousness, etc. of each target feature. For example, between two target features, one target feature may be given a lower priority for being more generic and ambiguous (e.g., a human) than the other target feature (e.g., a woman), or one target feature (e.g., three dogs on a boat) may be given a higher priority for being more specific and detailed than the second target feature (e.g., dogs). In an implementation, the user indention data 410 that is not in a text or image data format may be converted to text or image data. For example, the video data 414 showing a person walking three dogs in a park may be converted to one or more images showing the target feature or features (e.g., three dogs, etc.). As another example, the speech data 418 capturing the user's speech (e.g., “three dogs”) may be converted to a text containing the corresponding characters. As such, each target feature 430 maybe in a text format (e.g., “three dogs,” etc.) or an image format (e.g., a photo showing three dogs).

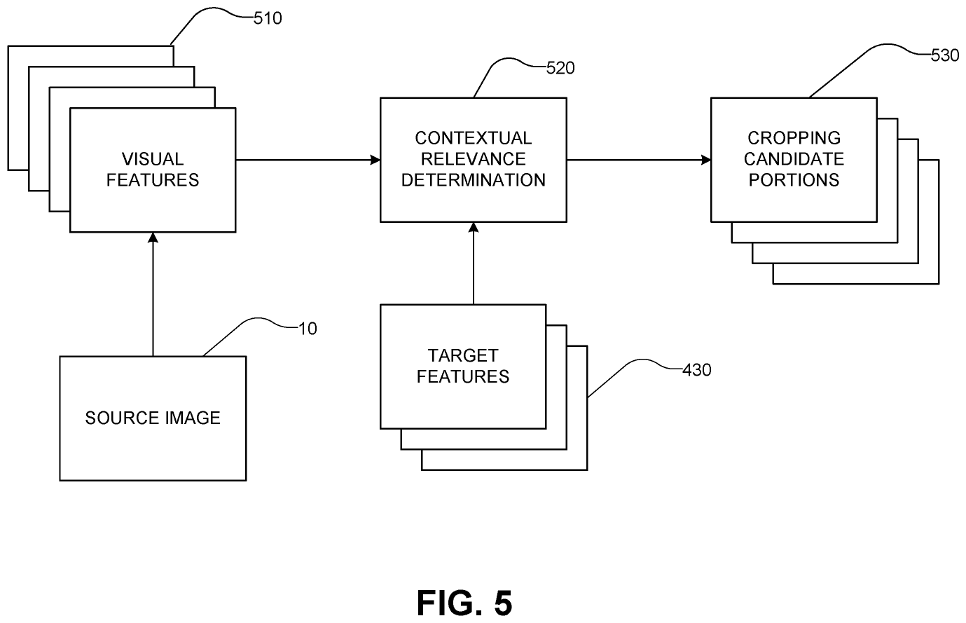

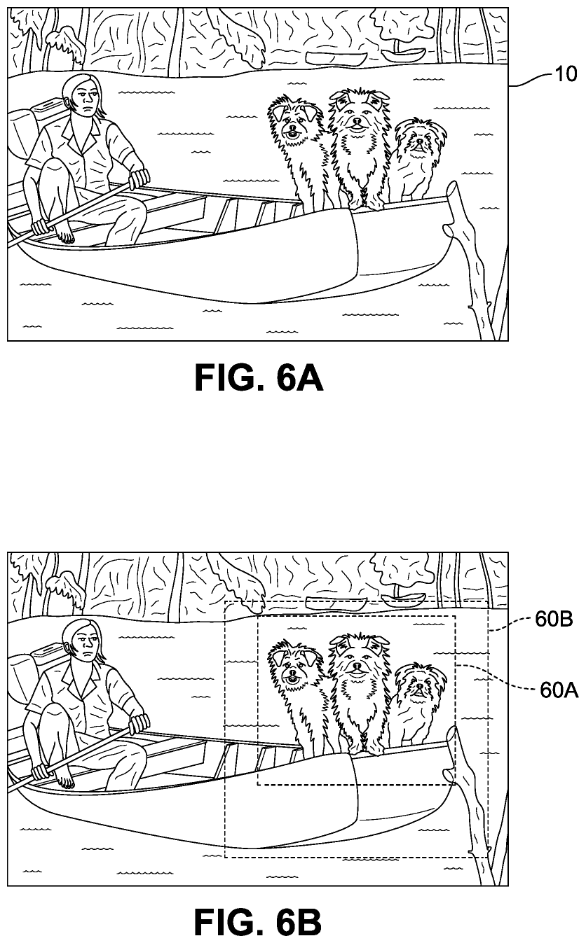

FIG. 5 conceptually illustrates an implementation of some of the steps (e.g., the steps 310, 312, 330 and 340) of the conditioned smart image cropping operation shown in FIG. 3. The system 100 may receive the source image 10 shown in FIG. 1 (also shown in FIG. 6A) and analyze the received source image 10 to identify one or more visual features 510 shown therein. The local device 110 may not have sufficient processing power to perform these steps. Hence, the system 100 may utilize the ML engine 130 to perform these steps. For example, the ML engine 130 may be trained to identify, from the source image 10, a number of visual features, for example, a river, a boat, a woman, three dogs, the boat floating on the river, the woman sitting on the boat, the woman rowing the boat, the woman positioned at the left side of the image 10, the three dogs standing on the boat, the three dogs facing toward a view of the image 10, the three dogs positioned at the right side of the image 10, etc.

The system 100 (e.g., server 120/ML engine 130) may then perform a contextual comparison between each target feature (see FIG. 4) and each visual feature of the source image 10 to determine a contextual relevance therebetween. For example, the system 100 (e.g., server 120/ML engine 130) may contextually compare the target feature 430 (e.g., three dogs) with each of the visual features 510 of the source image 10 to identify a portion or portions of the source image 10 that are contextually relevant to the target feature, which may result in identifying, for example, a portion 60A (shown in FIG. 6B) of the source image 10 as a cropping candidate portion. Then, another target feature 430 (e.g., three dogs on a boat) may be contextually compared with each of the visual features 510 of the source image 10, which may result in identifying, for example, a portion 60B (shown in FIG. 6B) of the source image 10 as another cropping candidate portion.

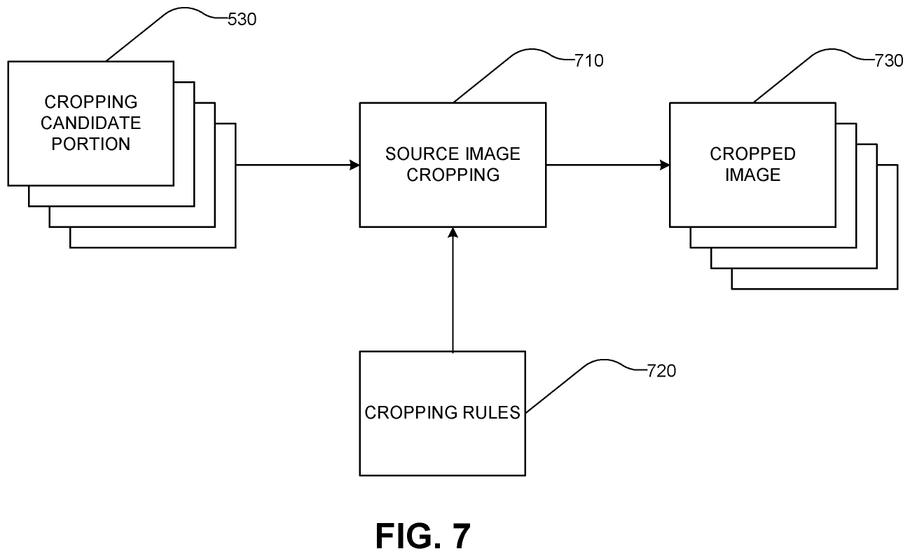

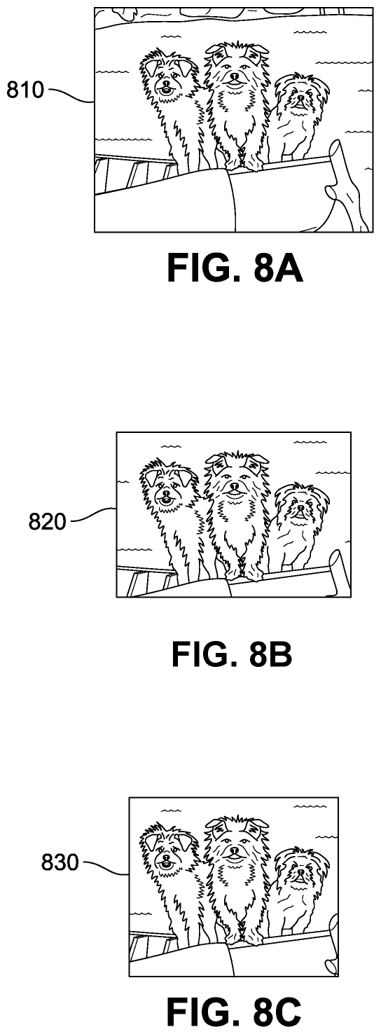

FIG. 7 conceptually illustrates an implementation of the step 350 shown in FIG. 3, at which source image cropping 710 is performed to generate a set of cropped images 730. The cropping candidate portions 530 resulted from the contextual relevance determination 520 (shown in FIG. 5) may be contextually relevant to the one or more target features, but may not be in an optimal configuration (e.g., a size, aspect ratio, aesthetical value, etc.). For example, the cropping candidate portion 60A (shown in FIG. 6), which prominently shows three dogs, might have a very high contextual relevance (e.g., higher than 90%) to the “three dogs” target feature, but may not be in a required or desired size, aspect ratio, etc. for general or particular usage scenarios (e.g., a newspaper advertisement for promoting a dog adoption day, etc.). Also, if used without any modification, the three dogs shown in the cropping candidate portion 60A may be excessively prominent and hence may not be aesthetically pleasing. Hence, when the source image cropping 710 is performed based on the cropping candidate portions 530, the system 100 may consider one or more cropping rules 720 for diversifying the aspect ratio, improving an aesthetical value, etc. For example, as shown in FIG. 8A, the system 100 may crop the image 10 to generate a cropped image 810 that has a larger size than the cropping candidate portion 60A such that more background is shown and the three dogs are not excessively prominent.

The system 100 may repeat cropping the source image 10 to generate more cropped images (e.g., cropped images 820 and 830 respectively shown in FIGS. 8B and 8C) having different configurations, characteristics, visual impressions, aesthetical values, and/or the like. The ML engine 130 may be used to perform at least some of functions of the cropping at the step 350. For example, the ML engine 130 may be trained to create and update the cropping rules 720 based on usage data/statistics, user preferences, esthetical evaluation statistics, etc. Such rules may include a set of guidelines on how the source image 10 should be cropped. For example, the cropping rules 720 may guide that a boundary of the cropped image should be at a predetermined distance from the visual feature contextually corresponding to the target feature. Also, the cropping rules 720 may dictate a size and location of the visual feature with respect to the entire cropped image 730. The cropping rules 720 may also include various commonly used image configurations (e.g., image sizes, aspect ratios, image types, image compression ratios, data size limitations, etc.) which may be required by media/content creation industries, social networking platforms, etc.

The system 100 may then cause the set of cropped images 730 to be available for the user. For example, the system 100 may transmit the cropped images 730 and cause the cropped images 730 to be displayed on the display 114 of the local device 110. The user may then select one or more of cropped images 730 for use in a visual content creation project (e.g., a newspaper advertisement for promoting a dog adoption day). As such, the system 100 may produce, on behalf of the user, a set of cropped images 73, which is aesthetically-pleasing and highly relevant to the user's need. Hence, this disclosure provides technical solutions to the technical problems that, in order to create images showing desired visual features, the user has to manually edit (e.g., crop, resize, etc.) image by himself or herself, which is time consuming and could not be easily replicated even with a state-of-art machinery.

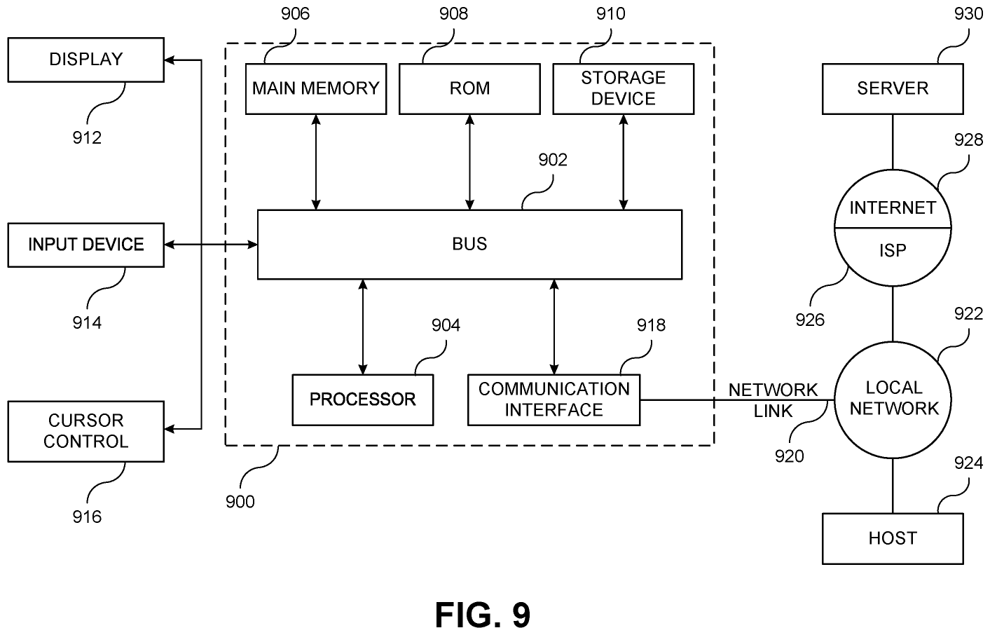

FIG. 9 is a block diagram showing an example a computer system 900 upon which aspects of this disclosure may be implemented. The computer system 900 may include a bus 902 or other communication mechanism for communicating information, and a processor 904 coupled with the bus 902 for processing information. The computer system 900 may also include a main memory 906, such as a random-access memory (RAM) or other dynamic storage device, coupled to the bus 902 for storing information and instructions to be executed by the processor 904. The main memory 906 may also be used for storing temporary variables or other intermediate information during execution of instructions to be executed by the processor 904. The computer system 900 may implement, for example, the local device 110, server 120, ML engine 130, etc.

The computer system 900 may further include a read only memory (ROM) 908 or other static storage device coupled to the bus 902 for storing static information and instructions for the processor 904. A storage device 910, such as a flash or other non-volatile memory may be coupled to the bus 902 for storing information and instructions.

The computer system 900 may be coupled via the bus 902 to a display 912, such as a liquid crystal display (LCD), for displaying information. One or more user input devices, such as the example user input device 914 may be coupled to the bus 902, and may be configured for receiving various user inputs, such as user command selections and communicating these to the processor 904, or to the main memory 906. The user input device 914 may include physical structure, or virtual implementation, or both, providing user input modes or options, for controlling, for example, a cursor, visible to a user through display 912 or through other techniques, and such modes or operations may include, for example virtual mouse, trackball, or cursor direction keys.

The computer system 900 may include respective resources of the processor 904 executing, in an overlapping or interleaved manner, respective program instructions. Instructions may be read into the main memory 906 from another machine-readable medium, such as the storage device 910. In some examples, hard-wired circuitry may be used in place of or in combination with software instructions. The term “machine-readable medium” as used herein refers to any medium that participates in providing data that causes a machine to operate in a specific fashion. Such a medium may take forms, including but not limited to, non-volatile media, volatile media, and transmission media. Non-volatile media may include, for example, optical or magnetic disks, such as storage device 910. Transmission media may include optical paths, or electrical or acoustic signal propagation paths, and may include acoustic or light waves, such as those generated during radio-wave and infra-red data communications, that are capable of carrying instructions detectable by a physical mechanism for input to a machine.

The computer system 900 may also include a communication interface 918 coupled to the bus 902, for two-way data communication coupling to a network link 920 connected to a local network 922. The network link 920 may provide data communication through one or more networks to other data devices. For example, the network link 920 may provide a connection through the local network 922 to a host computer 924 or to data equipment operated by an Internet Service Provider (ISP) 926 to access through the Internet 928 a server 930, for example, to obtain code for an application program.

In the following, further features, characteristics and advantages of the invention will be described by means of items:

Item 1. A system for cropping an image, comprising: a processor; and a computer-readable medium in communication with the processor, the computer-readable medium comprising instructions that, when executed by the processor, cause the processor to control the system to perform functions of: receiving a source image and user intention data; determining a target feature based on the user intention data; identifying a plurality of visual features within the source image; determining a contextual relevance between the target feature and each identified visual feature of the source image; identifying, based on the determined contextual relevance between the target feature and each identified visual feature of the source image, one or more cropping candidate portions within the source image; cropping, based on the one or more cropping candidate portions, the source image to generate a plurality of cropped images; and causing the plurality of cropped images to be displayed on a display.

Item 2. The system of item 1, wherein the user intention data includes at least one of text data, audio data, image data and video data containing content characterizing the target feature.

Item 3. The system of item 1, wherein: the user intention data includes video data containing content characterizing the target feature, and for determining the target feature, the instructions, when executed by the processor, further cause the processor to control the system to perform functions of: converting the video data to one or more images; and analyzing the one or more images to identify the target feature.

Item 4. The system of item 1, wherein: the user intention data includes audio data capturing a speech characterizing the target feature, and for determining the target feature to be extracted from the source image, the instructions, when executed by the processor, further cause the processor to control the system to perform functions of: converting the speech captured in the audio data to a text; and analyzing the text to identify the target feature.

Item 5. The system of item 1, wherein the instructions, when executed by the processor, further cause the processor to control the system to perform a function of providing the source image to a machine learning (ML) engine trained to perform the functions of: identifying the plurality of visual features within the source image; determining the contextual relevance between the target feature and each visual feature of the source image; and identifying, based on the determined contextual relevance, the plurality of cropping candidate portions within the source image.

Item 6. The system of item 1, wherein, for cropping the source image to generate the plurality of cropped images, the instructions, when executed by the processor, further cause the processor to control the system to perform cropping, based on a set of cropping rules, the source image, the set of cropping rules being determined based on at least one of usage data/statistics, user preferences and esthetical evaluation statistics.

Item 7. The system of item 1, wherein the cropping rules include at least one of an image size and aspect ratio.

Item 8. The system of item 1, wherein, for determining the target feature, the instructions, when executed by the processor, further cause the processor to control the system to perform determining a plurality of target features based on the user intention data.

Item 9. The system of item 8, wherein, for determining the contextual relevance between the target feature and each visual feature of the source image, the instructions, when executed by the processor, further cause the processor to control the system to perform determining the contextual relevance between each target feature and each visual feature of the source image.

Item 10. The system of item 8, wherein the instructions, when executed by the processor, further cause the processor to control the system to prioritize the plurality of target features based on contextual broadness or ambiguousness of each target feature.

Item 11. A method of cropping an image, comprising: receiving a source image and user intention data; determining a target feature based on the user intention data; identifying a plurality of visual features within the source image; determining a contextual relevance between the target feature and each identified visual feature of the source image; identifying, based on the determined contextual relevance between the target feature and each identified visual feature of the source image, one or more cropping candidate portions within the source image; cropping, based on the one or more cropping candidate portions, the source image to generate a plurality of cropped images; and causing the plurality of cropped images to be displayed on a display.

Item 12. The method of item 11, wherein the user intention data includes at least one of text data, audio data, image data and video data containing content characterizing the target feature.

Item 13. The method of item 11, wherein: the user intention data includes video data containing content characterizing the target feature, and determining the target feature comprises: converting the video data to one or more images; and analyzing the one or more images to identify the target feature.

Item 14. The method of item 11, wherein: the user intention data includes audio data capturing a speech characterizing the target feature, and determining the target feature comprises: converting the speech captured in the audio data to a text; and analyzing the text to identify the target feature.

Item 15. The method of item 11, further comprising providing the source image to a machine learning (ML) engine, wherein the ML engine is trained to perform: identifying the plurality of visual features within the source image; determining the contextual relevance between the target feature and each visual feature of the source image; and identifying, based on the determined contextual relevance, the plurality of cropping candidate portions within the source image.

Item 16. The method of item 11, wherein cropping the source image to generate the plurality of cropped images comprises cropping, based on a set of cropping rules, the source image, the set of cropping rules being determined based on at least one of usage data/statistics, user preferences and esthetical evaluation statistics.

Item 17. The method of item 11, wherein the cropping rules include at least one of an image size and aspect ratio.

Item 18. The method of item 11, wherein: determining the target feature comprises determining a plurality of target features based on the user intention data, and determining the contextual relevance between the target feature and each visual feature of the source image comprises determining the contextual relevance between each target feature and each visual feature of the source image.

Item 19. The method of item 18, further comprising prioritizing the plurality of target features based on contextual broadness or ambiguousness of each target feature.

Item 20. A non-transitory computer-readable medium comprising instructions that, when executed by a processor, cause the processor to control a system to perform: receiving a source image and user intention data; determining a target feature based on the user intention data; identifying a plurality of visual features within the source image; determining a contextual relevance between the target feature and each identified visual feature of the source image; identifying, based on the determined contextual relevance between the target feature and each identified visual feature of the source image, one or more cropping candidate portions within the source image; cropping, based on the one or more cropping candidate portions, the source image to generate a plurality of cropped images; and causing the plurality of cropped images to be displayed on a display.

In the above detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A system for cropping an image, comprising:
a processor; and
a computer-readable medium in communication with the processor, the computer-readable medium comprising instructions that, when executed by the processor, cause the processor to control the system to perform functions of:
receiving a source image and user intention data;
determining a target feature based on the user intention data;
identifying a plurality of visual features within the source image;
determining a contextual relevance between the target feature and each identified visual feature of the source image;
identifying, based on the determined contextual relevance between the target feature and each identified visual feature of the source image, one or more cropping candidate portions within the source image;
cropping, based on the one or more cropping candidate portions, the source image to generate a plurality of cropped images; and
causing the plurality of cropped images to be displayed on a display.

2. The system of claim 1, wherein the user intention data includes at least one of text data, audio data, image data and video data containing content characterizing the target feature.

3. The system of claim 1, wherein:
the user intention data includes video data containing content characterizing the target feature, and
for determining the target feature, the instructions, when executed by the processor, further cause the processor to control the system to perform functions of:
converting the video data to one or more images; and
analyzing the one or more images to identify the target feature.

4. The system of claim 1, wherein:
the user intention data includes audio data capturing a speech characterizing the target feature, and
for determining the target feature to be extracted from the source image, the instructions, when executed by the processor, further cause the processor to control the system to perform functions of:
converting the speech captured in the audio data to a text; and
analyzing the text to identify the target feature.

5. The system of claim 1, wherein the instructions, when executed by the processor, further cause the processor to control the system to perform a function of providing the source image to a machine learning (ML) engine trained to perform the functions of:
identifying the plurality of visual features within the source image;
determining the contextual relevance between the target feature and each visual feature of the source image; and
identifying, based on the determined contextual relevance, the plurality of cropping candidate portions within the source image.

6. The system of claim 1, wherein, for cropping the source image to generate the plurality of cropped images, the instructions, when executed by the processor, further cause the processor to control the system to perform cropping, based on a set of cropping rules, the source image, the set of cropping rules being determined based on at least one of usage data/statistics, user preferences and esthetical evaluation statistics.

7. The system of claim 1, wherein the cropping rules include at least one of an image size and aspect ratio.

8. The system of claim 1, wherein, for determining the target feature, the instructions, when executed by the processor, further cause the processor to control the system to perform determining a plurality of target features based on the user intention data.

9. The system of claim 8, wherein, for determining the contextual relevance between the target feature and each visual feature of the source image, the instructions, when executed by the processor, further cause the processor to control the system to perform determining the contextual relevance between each target feature and each visual feature of the source image.

10. The system of claim 8, wherein the instructions, when executed by the processor, further cause the processor to control the system to prioritize the plurality of target features based on contextual broadness or ambiguousness of each target feature.

11. A method of cropping an image, comprising:
receiving a source image and user intention data;
determining a target feature based on the user intention data;
identifying a plurality of visual features within the source image;
determining a contextual relevance between the target feature and each identified visual feature of the source image;
identifying, based on the determined contextual relevance between the target feature and each identified visual feature of the source image, one or more cropping candidate portions within the source image;
cropping, based on the one or more cropping candidate portions, the source image to generate a plurality of cropped images; and
causing the plurality of cropped images to be displayed on a display.

12. The method of claim 11, wherein the user intention data includes at least one of text data, audio data, image data and video data containing content characterizing the target feature.

13. The method of claim 11, wherein:
the user intention data includes video data containing content characterizing the target feature, and
determining the target feature comprises:
converting the video data to one or more images; and
analyzing the one or more images to identify the target feature.

14. The method of claim 11, wherein:
the user intention data includes audio data capturing a speech characterizing the target feature, and
determining the target feature comprises:
converting the speech captured in the audio data to a text; and
analyzing the text to identify the target feature.

15. The method of claim 11, further comprising providing the source image to a machine learning (ML) engine, wherein the ML engine is trained to perform:
identifying the plurality of visual features within the source image;
determining the contextual relevance between the target feature and each visual feature of the source image; and
identifying, based on the determined contextual relevance, the plurality of cropping candidate portions within the source image.

16. The method of claim 11, wherein cropping the source image to generate the plurality of cropped images comprises cropping, based on a set of cropping rules, the source image, the set of cropping rules being determined based on at least one of usage data/statistics, user preferences and esthetical evaluation statistics.

17. The method of claim 11, wherein the cropping rules include at least one of an image size and aspect ratio.

18. The method of claim 11, wherein:
determining the target feature comprises determining a plurality of target features based on the user intention data, and
determining the contextual relevance between the target feature and each visual feature of the source image comprises determining the contextual relevance between each target feature and each visual feature of the source image.

19. The method of claim 18, further comprising prioritizing the plurality of target features based on contextual broadness or ambiguousness of each target feature.

20. A non-transitory computer-readable medium comprising instructions that, when executed by a processor, cause the processor to control a system to perform:
receiving a source image and user intention data;
determining a target feature based on the user intention data;
identifying a plurality of visual features within the source image;
determining a contextual relevance between the target feature and each identified visual feature of the source image;
identifying, based on the determined contextual relevance between the target feature and each identified visual feature of the source image, one or more cropping candidate portions within the source image;
cropping, based on the one or more cropping candidate portions, the source image to generate a plurality of cropped images; and
causing the plurality of cropped images to be displayed on a display.
